(19) United States
(12) Patent Application Publication
(10) Pub. No.: US 2014/0067526 A1
(43) Pub. Date: Mar. 6, 2014

(54) Methods, Systems and Apparatuses for Analyzing and Comparing Return on Investment Performance of Marketing Channels in Integrated Marketing Campaigns

(71) Applicant: Deepthi Raju, Sugar Land, TX (US)

(72) Inventor: Deepthi Raju, Sugar Land, TX (US)

(73) Assignee: SMARTBRIDGE, LLC, Houston, TX (US)

(21) Appl. No.: 13/597,240

(22) Filed: Aug. 28, 2012

(51) Int. Cl. G06Q 30/02

(52) U.S. Cl. 705/14.46

(57) ABSTRACT

Methods, systems and apparatuses are disclosed for collecting cost data regarding advertisements of an offering through two or more marketing channels over a time period and, in near real time, revenue data generated by the marketing campaign. The cost data and the revenue data are grouped into a desired level of granularity. The returns on investment for the desired level of granularity are calculated and displayed. Other embodiments are also disclosed and claimed.

### RELATED APPLICATIONS

This patent application relates to the following commonly assigned co-pending applications entitled:

“Methods, Systems and Apparatuses for Analyzing the Effectiveness of Broadcast Advertising in and on Integrated Marketing Campaigns” Ser. No. ______, filed Aug. 28, 2012, and “Methods, Systems and Apparatuses for Analyzing and Comparing Performance of Marketing Channels in Integrated Marketing Campaigns,” Ser. No. ______, filed Aug. 28, 2012, all of which are incorporated in their entireties by reference herein.

### TECHNICAL FIELD OF THE INVENTION

The present disclosure relates generally to systems, methods, and apparatuses for analyzing marketing. More particularly, the disclosure relates to systems, methods and apparatuses for analyzing and comparing return on investment for media advertising in near real time.

### BACKGROUND

Firms, small businesses, and individuals offering goods or services—and even non-profits—often spend considerable amounts of money for advertisement. In an article entitled “U.S. advertising spending totaled $144 billion in 2011,” dated Mar. 13, 2012, the LA Times reported that, according to data from Kantar Media, advertising expenditures in the United States totaled $144 billion (USD) in 2011. Some of the media channels include television, radio, print, and online/digital methods. Examples of online/digital methods include online advertisements, social media, and e-mail advertising.

In order to determine whether their advertising dollars are being well spent, advertisers need to be able to compare results from different advertising campaigns and compare results when the advertising is performed through different channels. Commonly assigned and co-pending U.S. patent application Ser. No. ______, entitled “Methods, Systems and Apparatuses for Analyzing and Comparing Performance of Marketing Channels in Integrated Marketing Campaigns,” addresses such issues. However, U.S. patent application Ser. No. ______ does not teach methods, systems and apparatuses for determination or a comparison of returns on investment (“ROI”).

Traditional methods used by companies to measure ROI for marketing expenditure allows marketers to understand overall returns, but such methods do not provide the ability to determine ROI at a specific marketing channel level or at any finer level of granularity

Accordingly, a need is present for methods, systems, and apparatuses to address and/or overcome issues discussed above.

### SUMMARY

The embodiments of the invention described herein include a method, which includes collecting by a specially programmed computer system over a time period, cost data for a marketing campaign for an offering of a vendor, the marketing campaign including at least two providers being from at least one marketing venue in at least one marketing channel, the at least two providers making marketing communications for the offering in the marketing campaign. The method also includes collecting by the specially programmed computer system, from a revenue data system in near real time, revenue data for the offering generated by the marketing campaign and obtaining, by the specially programmed computer system, a profit margin on at least a vendor level of granularity. The method further includes grouping, by the specially programmed computer system, of the cost data and the revenue data into categories for at least one desired level of granularity and separating any revenue data that cannot be grouped as ungrouped revenue data. The method includes pulling, by the specially programmed computer in near real time from a web analytics system, web site usage data about the impact of the marketing communications on a website relating to the offering. The method also includes correlating, by the specially programmed computer system, the web site usage data with the ungrouped revenue data to group the ungrouped revenue data into the categories for the at least one desired level of granularity. The method includes determining, by the specially programmed computer system, from the grouped cost data, the grouped revenue data and the profit margin, returns on investment (“ROI's”) at the at least one desired level of granularity and displaying, on a display in communication with by the specially programmed computer system, the determined ROI's on at the at least one desired level of granularity.

The embodiments of the invention described herein include an apparatus, which includes a return on investment (“ROI”) marketing performance measurement reporting system coupled to a cost system and also coupled to a revenue system. The ROI marketing performance measurement reporting system may collect from the cost system cost data for a marketing campaign, the marketing campaign including a plurality of marketing communications for an offering through two or more providers from at least one marketing venue in at least one marketing channel. The ROI marketing performance measurement reporting system may also collect in near real time, from the revenue system, revenue data generated from the marketing campaign, the revenue data, including a profit margin. The apparatus also includes a web analytics system, which obtains web site usage data related to a web site for the offering. The web analytics system is coupled to the ROI marketing performance measurement reporting system, so that the ROI marketing performance measurement reporting system may pull the web site usage data from the web analytics system. The ROI marketing performance measurement reporting system is further configured to group the cost data and the revenue data into categories at a desired level of granularity. The ROI marketing performance measurement reporting system further configured to determine ROI's for the categories on the desired level of granularity from the grouped cost data, the grouped revenue data and the profit margin. The apparatus also includes a display in communication with the ROI marketing performance measurement reporting system for displaying at least one of the determined ROI's.

The embodiments of the invention described herein include an article of manufacture which has a medium, storing instructions that, if executed, enable a processor-based system to collect, cost data for a marketing campaign including marketing communications for an offering through two or more marketing providers from a cost system coupled to the processor-based system, to collect, in near real time, revenue data generated by the marketing campaign, the revenue data collected from a revenue data system coupled to the processor-based system, to collect, in near real time, website usage data about the impact of the marketing communications on a website relating to the offering to group the cost data and the revenue data on at a desired level of granularity, to obtain a profit margin for a line of offerings including the offering, to determine a return on investment (“ROI”) on the desired level of granularity using the grouped cost data, the grouped revenue data system and the profit margin and to display the calculated return on investment.

The embodiments of the invention described herein include a system which includes an ROI marketing performance measurement reporting system, a cost data system coupled to the ROI marketing performance measurement reporting system and configured to collect over a period of time cost data for a marketing campaign, the marketing campaign including a plurality of marketing communications for an offering through two or more providers over the time period, the cost data system being further configured to send the cost data to the ROI marketing performance measurement reporting system, a revenue system for collecting revenue data generated from the marketing campaign, the revenue system coupled to the ROI marketing performance measurement reporting system, the ROI marketing performance measurement reporting system being configured to pull the revenue data from the revenue system in near real time, a web analytics system configured to obtain web site usage data related to a web site for the offering, wherein the web analytics system is coupled to the ROI marketing performance measurement reporting system, the ROI marketing performance measurement reporting system configured to pull the web site usage data from the web analytics system. The ROI marketing performance measurement reporting system is further configured to group the cost data and the revenue data into categories at a desired level of granularity and to determine ROI's for the categories on the desired level of granularity from the grouped cost data, the grouped revenue data and the profit margin. The system also includes a display in communication with the ROI marketing performance measurement reporting system for displaying at least one of the determined ROI's.

Other aspects and advantages of the embodiments described herein will become apparent from the following description and the accompanying drawings, illustrating the principles of the embodiments by way of example only.

### BRIEF DESCRIPTION OF THE DRAWINGS

Features and advantages of the present invention will become apparent from the appended claims, the following detailed description of one or more example embodiments, and the corresponding figures.

FIG. 1 is a block diagram depicting a system for analyzing and comparing the performance of marketing channels on the basis of ROI, in accordance with one or more embodiments of the present disclosure;

FIG. 2 is a flowchart depicting a process for analyzing and comparing the performance of marketing channels on the basis of ROI, in accordance with one or more embodiments of the present disclosure;

FIG. 3 is a diagram illustrating a process of collecting and analyzing data for determining and comparing the performance of marketing channels on the basis of ROI, in accordance with one or more embodiments of the present disclosure;

FIG. 4 is a bar graph illustrating a comparison of the performance of marketing channels on the basis of ROI, in accordance with one or more embodiments of the present disclosure;

FIG. 5 is a graph illustrating a comparison of the performance of marketing channels on the basis of revenue over a period of time, in accordance with one or more embodiments of the present disclosure;

FIG. 6 depicts an architecture, in accordance with one or more embodiments of the present disclosure, to implement the ROI marketing channel analysis system;

FIG. 7 is a screenshot of a summary display depicting details of marketing channel results impacting various pages of a web site, in accordance with one or more embodiments of the present disclosure;

FIG. 8 is a block diagram depicting a system for analyzing and comparing marketing channels (in this example, the performance of two marketing channels and three providers, with neither of the marketing channels comprising a broadcast marketing channel) on the basis of ROI, in accordance with one or more embodiments of the present disclosure;

FIG. 9 is a flowchart depicting a process for analyzing and comparing the performance of marketing channels (in this example, the performance of three marketing channels) on the basis of ROI, in accordance with one or more embodiments of the present disclosure; and

FIG. 10 is a block diagram depicting a system for analyzing and comparing marketing channels (in this example, the performance of two marketing channels and three providers, with one of the marketing channels comprising a broadcast marketing channel) on the basis of ROI, in accordance with one or more embodiments of the present disclosure.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but have similar functions. In the following discussion and in the claims, the terms “including” and “comprising” are used in an open-ended fashion, and thus should be interpreted to mean “including, but not limited to . . . ” In addition, the terms “couple”, “couples”, or “coupled” are intended to mean either an indirect or a direct connection. Thus, if a first device couples to a second device, that connection may be through a direct connection, or through an indirect connection via other devices and connections.

“The internet” is a network of networks and gateways that use the TCP/IP suite of protocols. “A client” is a computer, accessed by a user or viewer, which issues commands to another computer called “a server.” The server performs a task associated with the client's command. “The World Wide Web” (WWW or Web) is the internet's application which displays information on the internet in a user-friendly graphical user interface format called a Web page. “A Web server” typically supports one or more clients. The Web allows users (at a client computer) who seek information on the internet to switch from server to server and database to database by viewing objects (images or text) and clicking (with a pointing device or keystroke) on corresponding highlighted words or phrases of interest (hyperlinks).

The Web includes the internet with all of the resources addressed or identified as Universal Resource Locators (URLs), which displays the information corresponding to URLs and provides a point-and-click interface to other URLs. A URL can be thought of as a Web document version of an e-mail address. Part of a URL is termed the Internet Protocol (IP) address.

An internet browser or Web browser is a graphical interface tool that runs internet protocols and displays results on the user's screen. The browser can act as an internet tour guide, complete with pictorial desktops, directories, and search tools used when a user “surfs the net.”

The phrase “marketing channel,” as used herein, refers to different types of methods for advertising an offering, such as a product or service. Examples of marketing channels include e-mail marketing, online advertising, social media advertising, broadcast media advertising (which may include such venues as television advertising, newspaper advertising, catalogs and mass mailing), and search engine optimization. An advertisement is “exposed” when a page, which contains a slot with the advertisement, is served to a client accessing the page. Since a page may typically contain more than one slot, more than one advertisement may be exposed at a single time. The exposure of an advertisement is also called “an impression.” An advertisement is clicked when a client decides to choose (with a pointing device or keystroke) the link corresponding to an exposed advertisement. Thus, the number of clicks for an advertisement is always a certain fraction of the number of exposures. Advertisement agencies often measure the effectiveness of an advertisement by the number of clicks that an advertisement receives.

The terms “advertising” and “advertisement(s)” are used herein to mean communications made to a target audience through paid announcements, which may be made through various marketing channels, to promote an offering. The term “marketing communication” includes advertising, but may also include other promotional aspects of marketing, such as public relations, media relations, publicity, design of packaging and of web sites for firm or an offering, design and use of marks, use of endorsements, client development and retention, and social media. While some embodiments are described with respect to advertising, other embodiments may include other types of marketing communications. The examples of various embodiments should be considered illustrative rather than limiting.

The term “conversion,” as used herein, means a completion of a goal. Some examples of conversions include purchasing an offering, registering on a website, signing up for a service, or downloading a white paper.

The phrase “near real time,” as used herein, means almost in real time as events happen, allowing for updating by the provider (which may be done in near real time or on a periodic basis, depending upon the provider), transmission and processing of data, but without significant delay. Real time, if taken to mean absolutely simultaneously, may be unobtainable, as even light takes time to go from one point to another.

The abbreviation ROI means return (or returns) on investment. Comparisons, correlations and evaluations made on the basis of revenue, profit or ROI (or any combination thereof) are collectively referred to herein as “revenue-based comparisons.”

### DETAILED DESCRIPTION

In light of the principles and example embodiments described and illustrated herein, it will be recognized that the example embodiments can be modified in arrangement and detail without departing from such principles. In addition, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to any particular embodiment configurations. As used herein, these terms may reference the same or different embodiments that are combinable into other embodiments. Similarly, although example processes are described herein with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure also describes various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

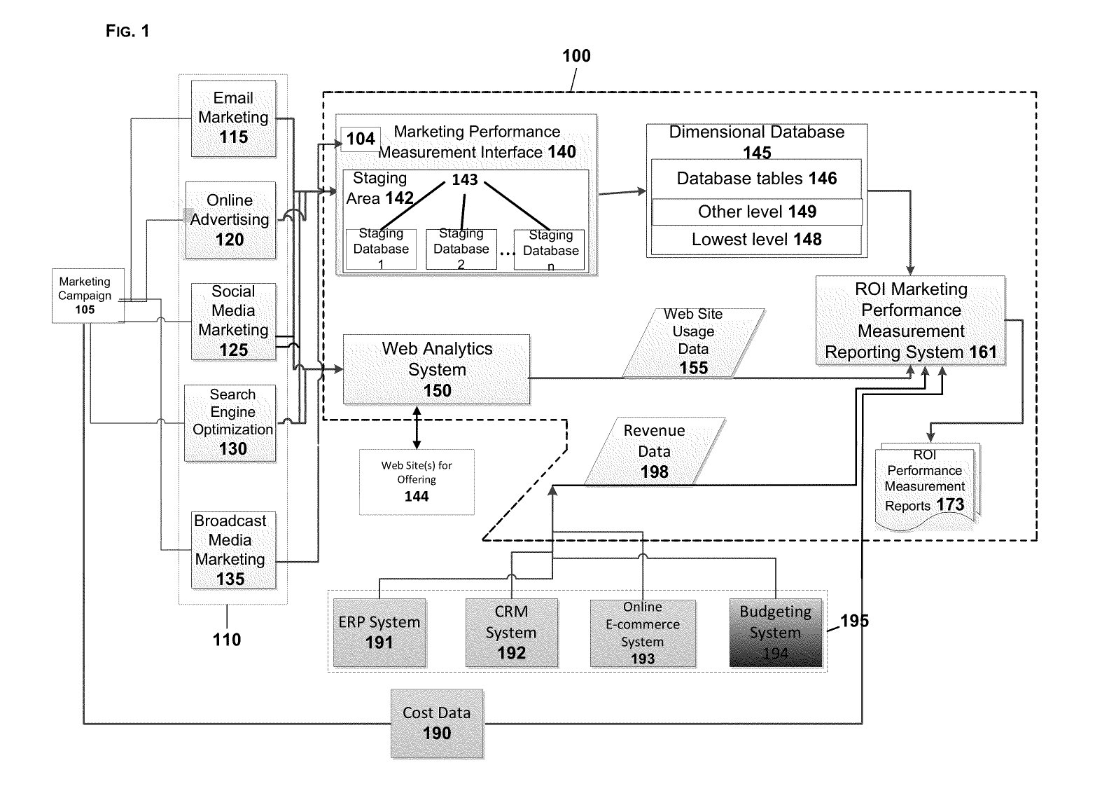

FIG. 1 is a block diagram depicting a marketing channel analysis system 100 for analyzing and comparing the performance of marketing channels on the basis of ROI, in accordance with one or more embodiments of the present disclosure. Referring to FIG. 1, a marketing campaign 105 is initiated using one or more marketing channels 110. The marketing channels 110 include one or more channels of advertising such as e-mail marketing 115, online advertising 120, social media marketing 125, search engine optimization 130, and/or broadcast media marketing 135. Each channel of advertising may include one or more providers that display the advertising.

The e-mail marketing 115 may include advertisements sent to one or more e-mail addresses. The e-mail addresses may be, as examples, from individuals who have registered with a particular goods and/or services provider, from individuals who are former customers (collected via cookies or other means), from other merchants selling e-mail lists, or from a supplier of e-mail addresses. Advertising through the online advertising channel 120 may be conducted by placing advertisements to be displayed on various web sites. The social media marketing 125 may be conducted through social media providers, such as Twitter®, Facebook®, LinkedIn®, or other such entities. The search engine optimization 130 may include placing advertisements that appear on a website when particular searches are performed, and may also include appending tags relating to search terms to one's website to increase the chances that the website will be found as a result of a particular search. The broadcast media marketing 135 may include advertisements placed in television, newspapers, magazines, and other broadcast media. Referring again to FIG. 1, marketing performance data are collected from each provider in each marketing channel 115, 120, 125, 130, other than the broadcast media marketing channel 135, in near real time by a marketing performance measurement interface 140. Broadcast marketing performance data, from the broadcast media marketing channel 135, is in a provider-specific format, preferably a spreadsheet format, and is loaded into a marketing measurement interface 104 within the marketing performance measurement interface 140. The marketing measurement interface 104 converts the broadcast marketing performance data from it provider-specific format (preferably a spreadsheet format) to a specialized format of factual data and dimensional data, as described in the previously mentioned co-pending patent application Ser. No. ______, entitled “Methods, Systems and Apparatuses for Analyzing the Effectiveness of Broadcast Advertising in and on Integrated Marketing Campaigns,” and mentioned in the Related Applications section herein.

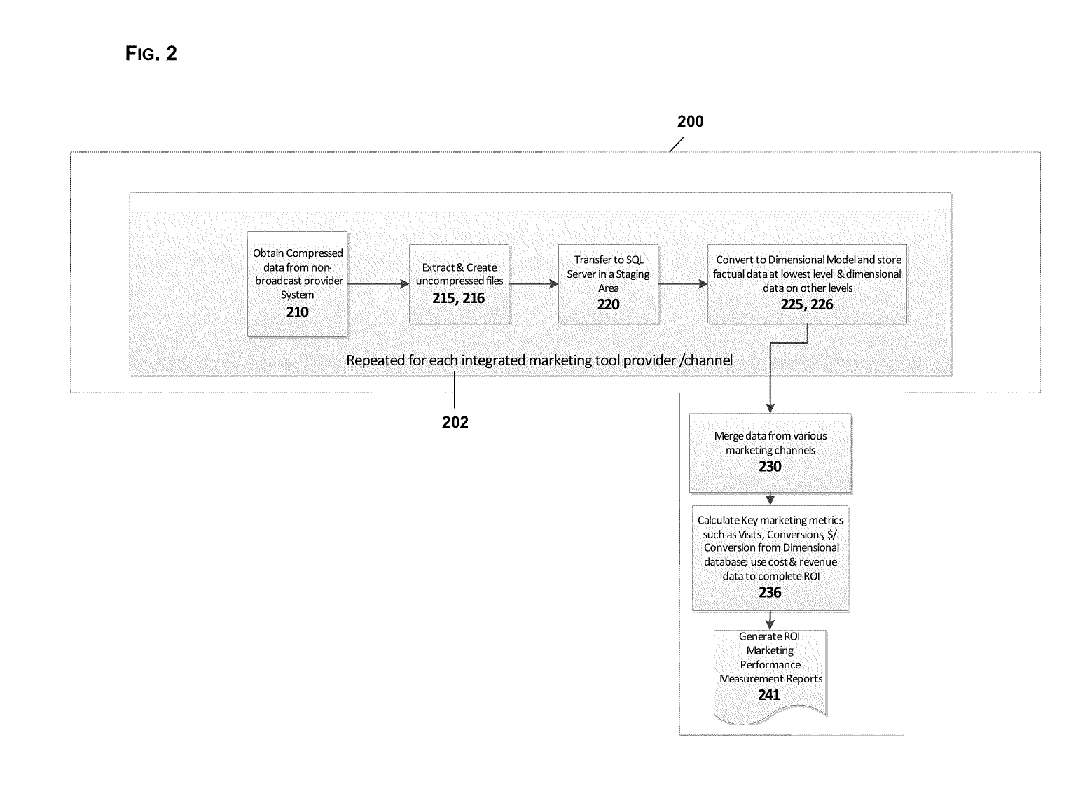

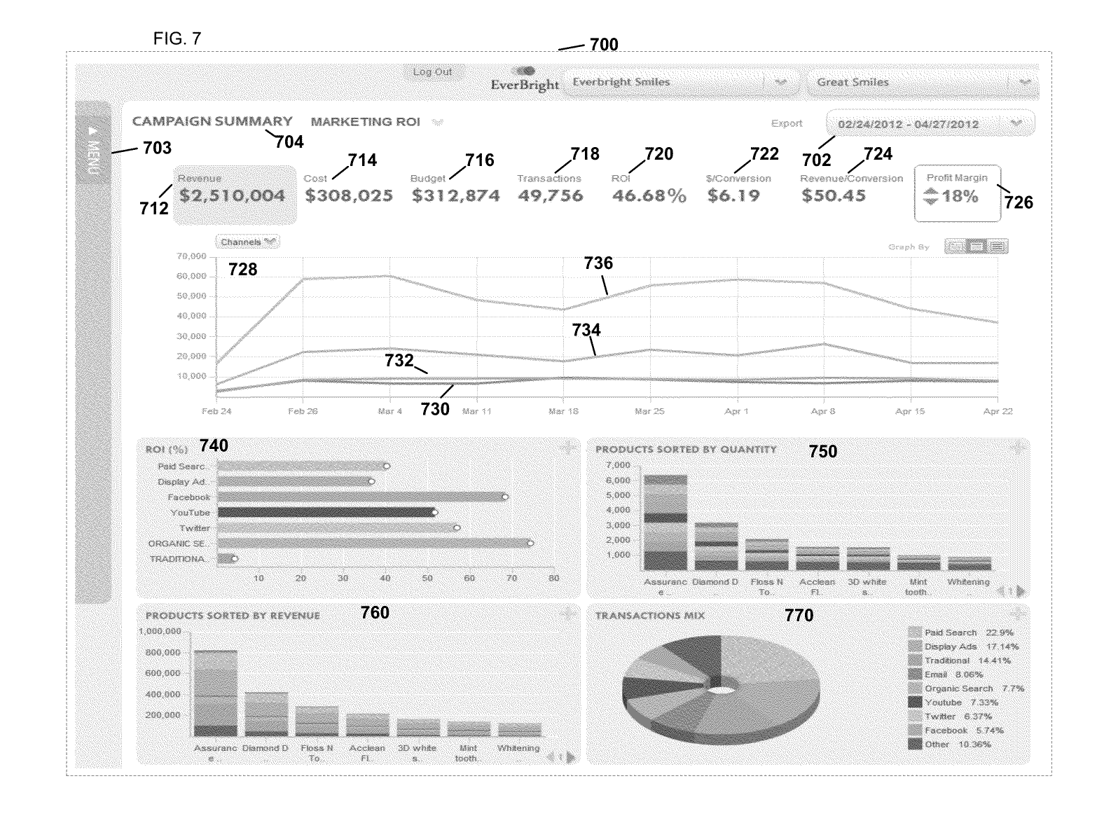

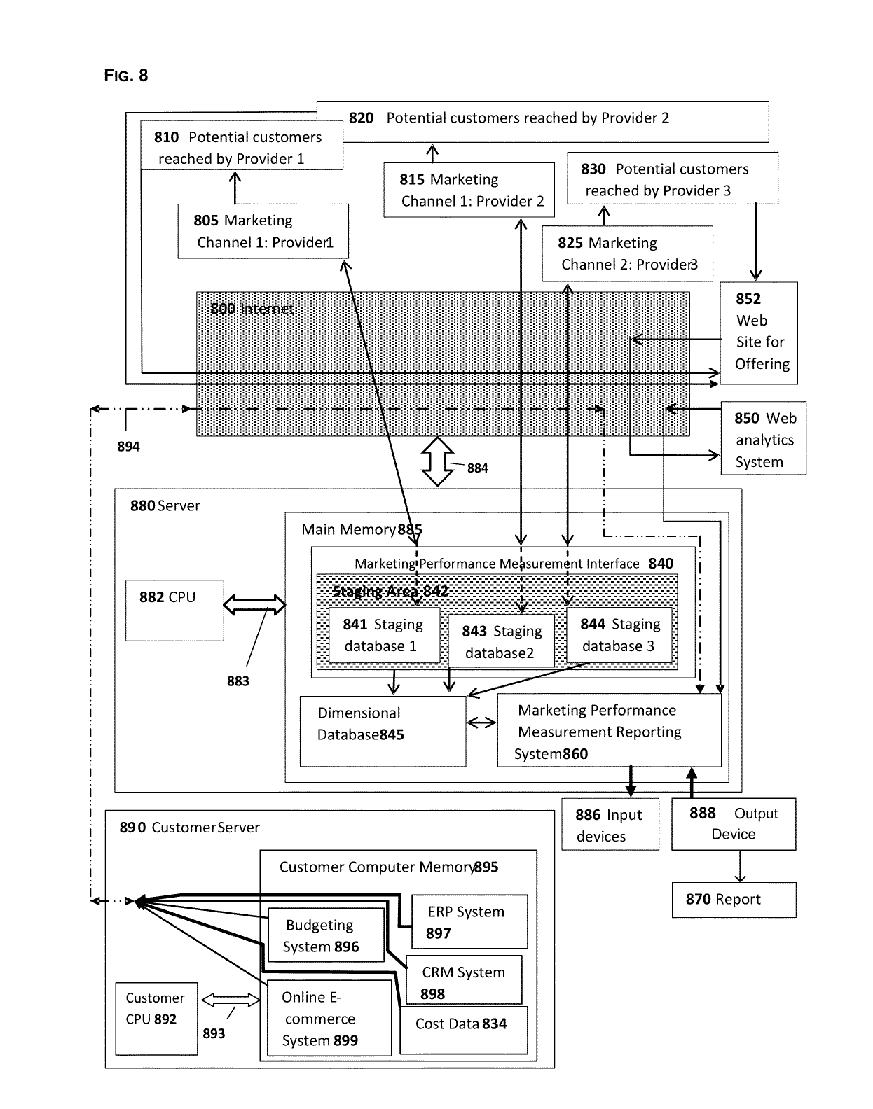

The marketing performance measurement interface 140 may use a provider-specific API to access and collect the marketing performance data from the non-broadcast media providers in near real time. (The collection and analysis of non-broadcast media marketing performance data is described in more detail in the discussion of FIG. 2 and of FIG. 7 herein.) The provider-specific API may be configured in any one of a number of ways, but interfacing with such provider-specific API's is understood in the art.

The marketing performance data for each channel generally includes information on the frequency and the scope of the advertising conducted through that channel. The marketing performance data may also include responses by potential customers if such data is collected by the provider. The marketing performance data may include a plurality of metrics specific to the channel. Thus, there might be e-mail marketing performance data metrics, online marketing performance data metrics, social media marketing performance data metrics, search engine optimization marketing performance data metrics, and/or broadcast media marketing performance data metrics. The marketing performance data metrics may even be specific to particular venues within the channel (such as television within the broadcast media channel) or to providers within the venues.

For example, the e-mail marketing performance data metrics may include information such as the number of e-mails which were sent, the number of the e-mail messages which were opened by the recipient, the number of e-mails sent which bounced and were not delivered, or the number of times recipients clicked on a web link in the e-mail. The on-line marketing performance data metrics may include the number of impressions, the number of clicks on the advertisement, a “click through rate,” the cost per click, and the cost per thousand of impressions. The broadcast media marketing performance data metrics may include net reach, frequency of advertisements, and the cost of the advertisements. The print performance data metrics may include impressions (that is, circulation) and the cost of the advertising.

The social media marketing channel performance information metrics may be different for different social media venues and providers. For example, for marketing communications placed through Facebook®, the social media marketing channel performance information metrics may include the number of Facebook® fans, the number of wall posts, the number of interactions, the number of video views, and/or the number of photo views. For marketing communications placed through Twitter®, the social media marketing channel performance information metrics may include the number of Twitter® followers, the number of tweets, the number of re-tweets, and the number of mentions.

Referring again to FIG. 1, the marketing performance measurement interface 140 includes a staging area 142 having one or more staging databases 143. Preferably, there is one staging database 143 for each non-broadcast marketing channel provider. As discussed in greater detail with respect to FIG. 2 and FIG. 7 herein, the marketing performance measurement interface 140 obtains the marketing performance data from each non-broadcast marketing channel provider in near real time, processes the marketing performance data and stores it in the staging database 143 for the appropriate non-broadcast marketing channel provider. As previously mentioned, the broadcast marketing performance data from the broadcast media marketing channel 135 is collected from broadcast providers and loaded into the marketing performance measurement interface 140. The broadcast marketing performance data is not loaded into the staging databases.

The marketing performance data for all channels is converted by the marketing performance measurement interface 140 from a provider-specific format to the specialized format of factual data and dimensional data. [As previously mentioned, the marketing measurement interface 104 (within the marketing performance measurement interface 140) converts the broadcast marketing performance data from its provider-specific format, preferably a spreadsheet format, to the specialized format.] Examples of factual data include the actual number of clicks of the ads or the visits to the website. Examples of dimensional data include the ads and the emails that have been sent out during the campaign.

The marketing performance measurement interface 140 sends the marketing performance data from all marketing channels in the specialized format of factual data and dimensional data to the dimensional database 145, having one or more database tables 146. Each database table has a lowest level 148 and one or more other levels 149. The factual data is preferably stored on the lowest levels 148 or the database tables 146, while the dimensional data is stored on other levels 149 in the database tables 146.

When a user wants updated data, a marketing performance measurement reporting system 160 pulls the appropriate factual data and dimensional data from the database tables 146 in the dimensional database 145 as database objects and presents the data for viewing in HTML.

When a potential customer sees an ad/creative from one of the advertisement displays in a marketing channel and clicks a link to come to a web page for the offering, traffic data is tracked by a web analytics software 150. The web analytics software 150 may be any robust web analytics software such as Google® Analytics, Yahoo® Analytics, or any such analytic service. The web analytics software 150 is used to track, in near real time, all customer activity on the client's website. The customer activity may have originated from any of the marketing channels 110. (There may even be customer activity un-related to the marketing channels 110.) The web analytics software 150 may use techniques, such as, for example, embedding tracking codes. A tracking code may be embedded in a url-link, which is placed in a website relating to an offering or in an e-mail advertisement for the offering. The tracking codes contain data about how the visitor arrived at the website and what the visitor does at the website. Referring again to FIG. 1, the output of the web analytics software 150 is a web site usage data collection (“web site usage data” 155). The marketing performance measurement reporting system 160 pulls the web site usage data 155 from the web analytics software 150.

Continuing to refer to FIG. 1, the marketing performance measurement reporting system 160 also pulls cost data 190 from a cost data source (not depicted), on at least a per marketing channel level of granularity, but the levels of granularity may vary. Some cost data 190 may be provided on a provider basis or on a finer level of granularity. For example, when the cost data 190 is collected from some providers of marketing communications, such as Facebook® Ads, the cost data may be on an advertisement (or marketing communication) level of granularity. The cost data 190 may be obtained from cost data systems with the customer providing the offering. The ROI marketing performance measurement reporting system 160 may pull the cost data 190, using a source-specific API (not separately depicted). (Some cost data may be collected in near real time, while other cost data may not be collected in near real time.).

Referring again to FIG. 1, the marketing performance measurement reporting system 160 also pulls revenue data 198 from at least one revenue data source 195. This may include all revenue for the offering derived during the time period of the marketing campaign, but is preferably collected on a near real time basis on a transaction/conversion basis (“conversion basis”) Examples of revenue data sources illustrated in FIG. 1 include an enterprise resource planning (“ERP”) system 191, a customer relationship management (“CRM”) system 192, an online e-commerce system 193, and a budgeting system 194. The ROI marketing performance measurement reporting system 161 may pull the revenue data 198 in near real time, using a source-specific API (not separately depicted). The ROI marketing performance measurement reporting system 161 groups the revenue data 198 and the cost data 190 into a desired level of granularity. If revenue from a particular transaction cannot be grouped, the ungrouped revenue is not grouped at this point.

Referring again to FIG. 1, the ROI marketing performance measurement reporting system 161 pulls marketing performance data from the dimensional database 145 and real time web site usage data 155 from the web analytics software 150, to use with the cost data 190 and the revenue data 198 to create one or more ROI performance measurement reports 173. The ROI marketing performance measurement reporting system 161 also correlates the web site usage data 155 with a specific user transaction/conversion for any ungrouped revenue data, to group the ungrouped data in the marketing channel (or marketing venue or provider) to which it belongs.

The ROI measurement reports may include comparisons/correlations made on the basis of revenue or ROI (or profit or any revenue-based comparison) and may include results at one or more layers of granularity, including by the overall marketing campaign, by marketing channel, by marketing venue or by provider.

FIG. 2 is a flowchart depicting a process 200 for collecting, storing, and analyzing non-broadcasting marketing performance data, as well as comparing the performance of different marketing channels to each other, in accordance with one or more embodiments of the present disclosure. For each non-broadcast marketing channel and/or provider, the marketing performance measurement interface 140 (not depicted in the flowchart of FIG. 2) obtains 210 a compressed data packet from a system of each provider displaying the advertisement or conversation. For the obtaining step 210, a background process within the marketing performance measurement interface 140 polls provider systems for new marketing performance data. The polling is preferably conducted continuously or at very short intervals. As the new marketing performance data becomes available in the form of the compressed data packet, the marketing performance measurement interface 140 extracts 215 the data from the compressed data packet and creates 216 uncompressed data packets for the data. The uncompressed data packets for each provider are transferred 220 to a corresponding staging database 143, such as a SQL server database, in the staging area 142 located in the marketing performance measurement interface 140. There is preferably one staging database for data from each provider. The uncompressed data packets are then converted 225 from a provider-specific format to the specialized format of facts and dimensional data. Facts are stored 226 at a lowest dimensional level 148 of the dimensional database 145. Dimensional data are stored at other levels 149 of the dimensional database 145. Data from the various marketing channels are merged 230 so that comparisons may be made and so that the effectiveness of the marketing campaign as a whole may be assessed. Key marketing metrics, such as number of web site visits (to a web site for the offering), number of conversions, and/or cost per conversion, are calculated 235 from data in the dimensional database; ROI is calculated 236 from the cost and the revenue data, at a desired level of granularity. An ROI marketing performance measurement report is generated 241, which compares the ROI performance of the two or more marketing channels. The ROI marketing performance measurement report may include comparisons/correlations made on the basis of revenue or ROI (or profit or any revenue-based comparison) and may include results at one or more layers of granularity.

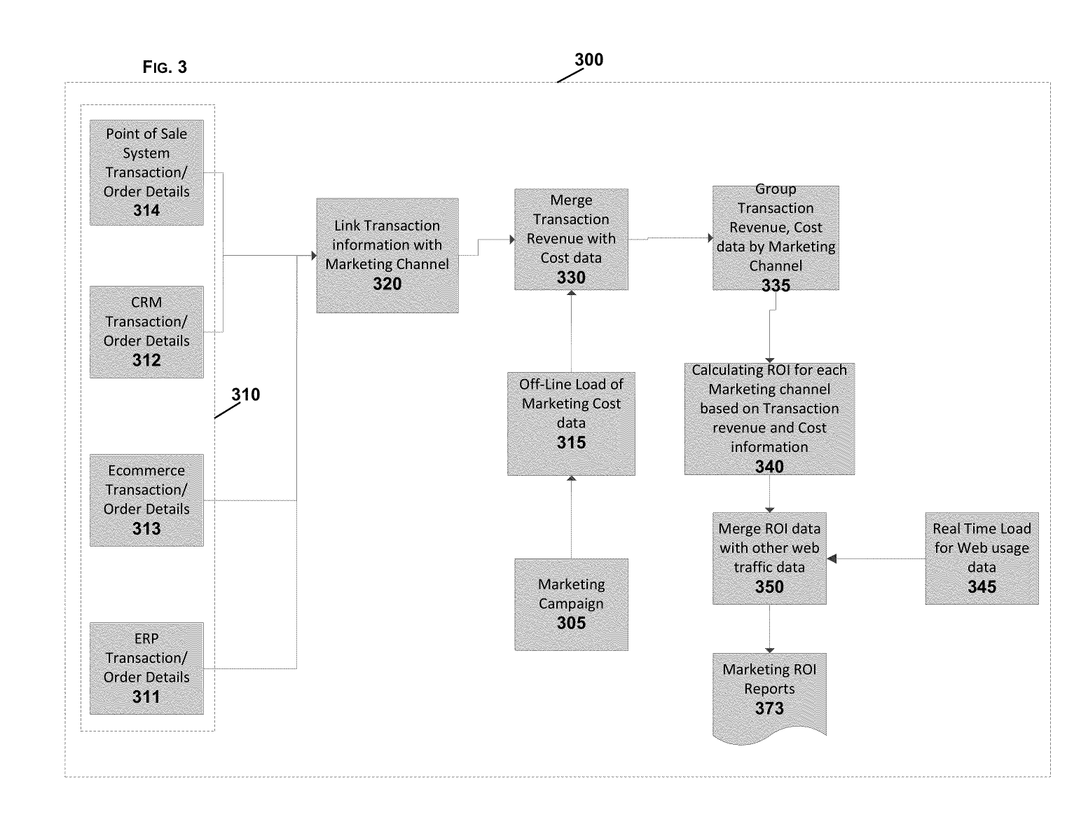

FIG. 3 is a block diagram illustrating a process 300 of determining and comparing the performance of marketing channels on the basis of ROI on a marketing channel basis, in accordance with one or more embodiments of the present disclosure. Revenue data 310 from one or more sources is collected. In the example of FIG. 3, the revenue data includes ERP transaction/order details 311, CRM transaction/order details 312, e-commerce transaction/order details 313, and point of sale system transaction/order details 314. Transaction information from the revenue data 310 is 320 linked with the marketing channel that generates the revenue, to determine revenue on a marketing channel level of granularity. (In alternative embodiments, the revenue data 310 may be linked to the provider for the marketing communication that generated the revenue, or to the marketing venue for the marketing communication that generated the revenue.) The marketing campaign 305 provides an off-line load 315 of marketing cost data. The marketing cost data are merged 330 with the transaction information. The revenue data and the cost data are grouped 335 by marketing channel. (In alternative embodiments, the revenue data and the cost data may be grouped by provider or by marketing venue.) The ROI for each marketing channel is calculated 340, based on the grouped transaction revenue and cost data for each marketing channel. (In alternative embodiments, the ROI may be calculated on other levels of granularity, using revenue data and the cost data at that level of granularity.) Web site usage data per marketing channel is uploaded 345 in near real time. The ROI for each marketing channel is merged 350 with the web site usage data for each marketing channel. One or more ROI performance measurement reports are created 373. The ROI performance measurement reports may include comparisons/correlations made on the basis of revenue or ROI (or profit or any revenue-based comparison) on a marketing channel basis. In alternative embodiments, the comparisons/correlations may include results at one or more layers of granularity.

In an alternative embodiment, in step 335, the transaction revenue and the cost data may be grouped by provider. The ROI for each provider may be calculated 340 based on the transaction revenue and cost data for each provider. Web site usage data per provider may be uploaded in step 345 in near real time. The ROI for each provider may be merged in step 350 with the web site usage data for each provider. ROI performance measurement reports, on a provider basis, may be created in step 373.

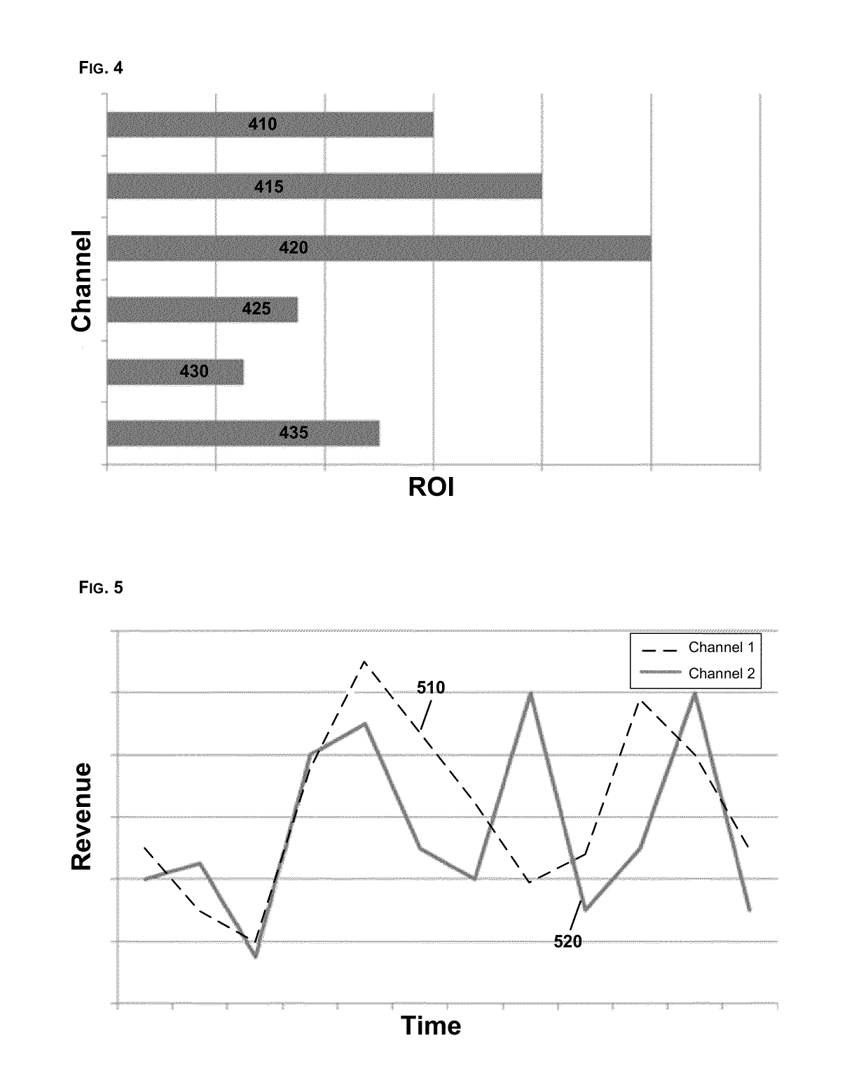

FIG. 4 is a bar graph illustrating a comparison of the performance of marketing channels on the basis of their ROI, in accordance with one or more embodiments of the present disclosure. In the example of FIG. 4, the ROI performance of six marketing channels 410, 415, 420, 425, 430, 435 are compared in an ROI performance measurement report. The x-axis of the graph is the ROI and results from different marketing channels are spaced along the y-axis. In the example of FIG. 4, the ROI performance for the marketing channel of bar 420 is the best, while the ROI performance for the marketing channel of bar 430 is the worst. In the ROI performance measurement reports, the bars may be labeled or fly-out menus/labels may be used.

FIG. 5 is a graph illustrating a comparison of the performance of two marketing channels on the basis of revenue (in the y-axis) over a period of time (in the x-axis), in accordance with one or more embodiments of the present disclosure. Revenue generated over time by a first marketing channel is indicated by curve 510, while revenue generated over the same time period by a second marketing channel is indicated by curve 520. As indicated by the revenue curves 510, 520, the first marketing channel generated more revenue than the second marketing channel in the same time period.

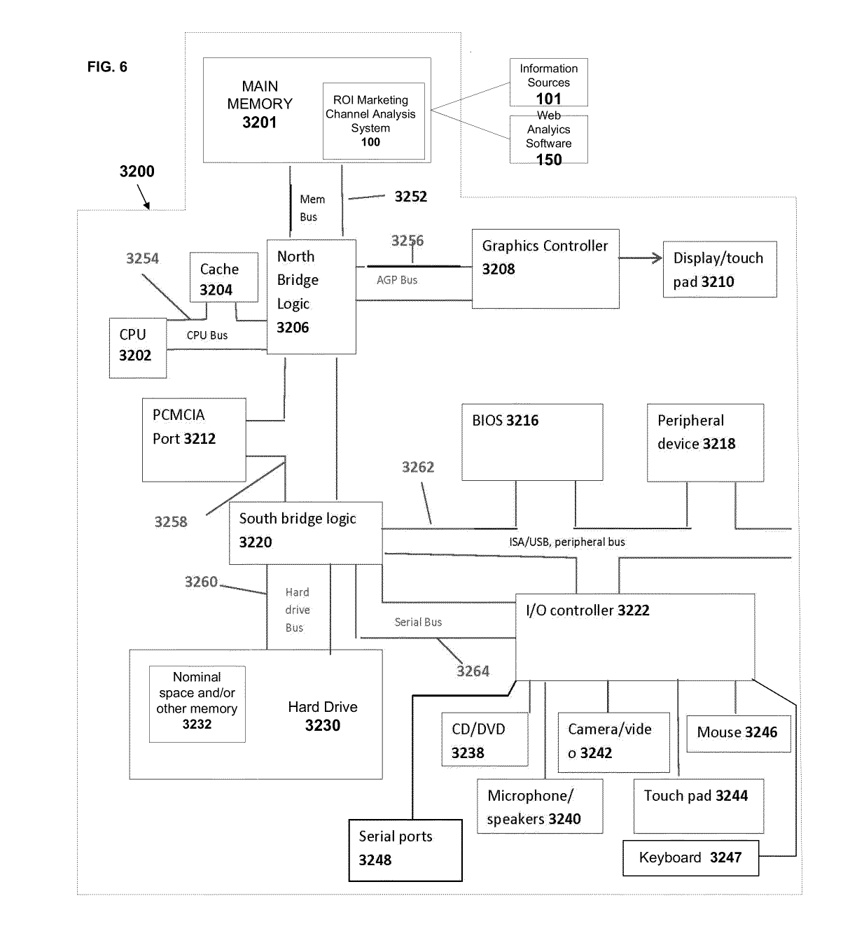

FIG. 6 will be discussed after FIGS. 7, 8, 9 and 10. FIG. 7 is a screenshot of a ROI performance measurement report prepared in accordance with one of more embodiments of the present disclosure. The ROI performance measurement report of FIG. 7 comprises a campaign summary display 700 depicting details of marketing channel results including ROI. The campaign summary display 700 covers multiple product offerings and includes a date range 702 for the information displayed within the campaign summary display 700. The campaign summary display 700 also includes a title 704 and a flyout menu 703 and, for the marketing campaign over the date range 702, total revenue 712, marketing costs 714, budget 716, number of transactions 718, ROI 720, cost per conversion 722, revenue per conversion 724, and profit margin 726. A revenue graph 728 depicts revenue per channel on curves 730, 732, 734, 736. An ROI bar chart 740 displays ROI per marketing channel or provider. (Three social media providers are broken displayed separately in the example of FIG. 7.) In a quantity bar chart 750, seven product offerings are sorted by quantity sold as attributed to multiple marketing channels, with contributions for each marketing channel stacked for each product offering and the contribution of each marketing channel indicated by color. In a revenue bar chart 760, seven product offerings are sorted by revenue as attributed to multiple marketing channels, with contributions for each marketing channel stacked for each product offering and the contribution of each marketing channel indicated by color. In a pie chart 770, the numbers of transactions attributable to particular marketing channels or providers are depicted. As with the ROI bar chart 740, the transaction results for three social media providers are displayed separately in the pie chart 770.

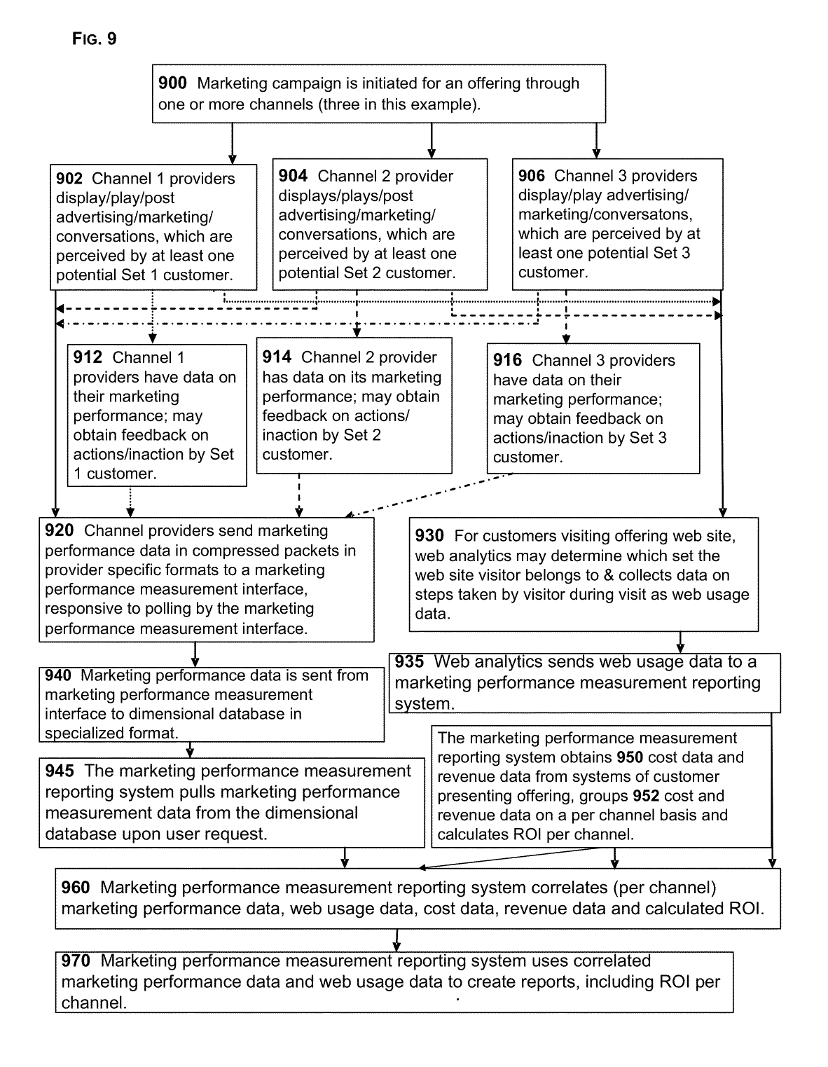

FIG. 8 is a block diagram depicting an example of a system for analyzing and comparing marketing channels on the basis of ROI, in accordance with one or more embodiments of the present disclosure. In the example of FIG. 8, there are two marketing channels and three providers. A provider 1 805 of a marketing channel 1, displays advertisements/marketing/conversations for an offering. Potential customers 810 reached by the provider 1 805 may respond by going to (or clicking through to) a website 852 for the offering, via the internet 800. (Some of the potential customers 810 reached by the provider 1 805 may respond in different ways or not at all.) A provider 2 815 of the marketing channel 1 displays advertisements/marketing/conversations for the offering. Potential customers 820 reached by the provider 2 815 may respond by going to (or clicking through to) the website 852 for the offering, via the internet 800. (Some of the potential customers 810 reached by the provider 2 815 may respond in different ways or not at all.) In some cases, the potential customers reached by one provider by overlap with the potential customers reached by another provider. In FIG. 8, the potential customers 820 reached by the provider 2 815 have a degree of overlap with the potential customers 810 reached by the provider 1 805. A provider 3 825 of marketing channel 2 displays advertisements/marketing/conversations for the offering. Potential customers 830 reached by the provider 3 825 may respond by going to (or clicking through to) the website 852 for the offering, via the internet 800. (Some of the potential customers 830 reached by the provider 3 825 may respond in different ways or not at all.) In FIG. 8, neither of the marketing channels 1 or 2 is a broadcast marketing channel.

Referring again to FIG. 8, a server (or other computer) 880 communicates over the internet 800 through an internet connection 884. (The server 800 of FIG. 8 is a simplified version; more detail of some components of a typical server or other computer in accordance with one or more embodiments of the present disclosure is provided in FIG. 6). Communications of different components of the server 800 with elements outside the server 800 are depicted as direct communications via the internet for clarity, but such communications would generally be routed through server 800 as is well known in the art and out the internet connection 884 to their destinations via the internet.) The internet connection 884 may be of any convenient kind, and may operate, for example, via hard wire or wirelessly. The server 880 has a central processing unit (“CPU”) 882 that may communicate through a bus 883 with a main memory 890. One or more input devices 886 and one or more output devices 888 allow user interaction with the server 880. Alternatively, the input devices 886 and/or the output devices 888 may be part of one or more client computer systems (not depicted in FIG. 8) in communication with the server 800.

Continuing to refer to FIG. 8, the main memory 890 of server 800 includes a marketing performance measurement interface 840. The marketing performance measurement interface 840 communicates through the internet connection 884 and the internet 800 with the provider 1 805, the provider 2 815 and the provider 3 825, and the marketing performance measurement interface 840, preferably by continuously polling the provider 1 805, the provider 2 815, and the provider 3 825 for marketing performance data. The marketing performance measurement interface 840 includes a staging area 842, having a staging database for each provider. Specifically, in this example, the staging area 842 includes a staging database 1 841, a staging database 2 843, and a staging database 3 844. The provider 1 805, the provider 2 815 and the provider 3 825 provide their respective marketing performance data to the marketing performance measurement interface 840, in the form of compressed packets of data in a format specific to the sending provider. The marketing performance measurement interface 840 extracts the marketing performance data from the compressed packets and stores the marketing performance data in the appropriate staging database 1 841, 2 843, or 3 844, depending on which provider provided the marketing performance data, as uncompressed data in the provider-specific formats. The marketing performance measurement interface 840 transforms the uncompressed marketing performance data from the provider-specific formats to a specialized format of factual data and dimensional data, which is sent to a dimensional database 845, where the marketing performance data in the form of factual data and dimensional data are stored. The factual data is preferably stored on the lowest level of the dimensional database.

Referring again to FIG. 8, a web analytics system 850 collects web usage information from the web site 852 and sends the web usage information to an ROI marketing performance measurement reporting system 860.

FIG. 8 also depicts a customer server 890, having a customer computer memory 895, a customer CPU 892, a customer computer bus 893, and a customer computer internet connection 894. The customer computer memory 895 includes a budgeting system 896, an ERP system 897, a CRM system 898, and an online e-commerce system 899. (In alternative embodiments, one or more of the budgeting system 896, the ERP system 897, the CRM system 898, or the online e-commerce system 899 may be present.) The customer computer memory 895 may also store cost data 834 for advertising through different marketing channels and/or providers. (In alternate embodiments, the cost data 834 may be obtained from other sources, such as the providers.) The ROI marketing performance measurement reporting system 860 pulls revenue information from one or more of the budgeting system 896, the ERP system 897, the CRM system 898, and/or the online e-commerce system 899, through the customer computer internet connection 894, via the internet 800. The revenue information preferably includes a profit margin for either the offering, a line of products or services including the offering or overall for the vendor making the offering. The cost data 834 is sent through the customer computer internet connection 894 and via the internet 800 to the ROI marketing performance measurement reporting system 860. The ROI marketing performance measurement reporting system 860 groups the cost data and the revenue data into the marketing channels to which the cost data and the group data relate.

The ROI marketing performance measurement reporting system 860 pulls the factual data and the dimensional data from the dimensional database 845. The ROI marketing performance measurement reporting system 860 correlates the factual data and the dimensional data with the web usage information correlates the web usage information with the cost data and the revenue information, the correlations being done (in the embodiment of FIG. 8) on a per channel basis. The ROI marketing performance measurement reporting system 860 uses the cost data and revenue data for each channel to calculate ROI of that channel. The calculation of ROI per channel may use Equation 1 (“Eq. 1”), where ROI per channel equals (profit per channel less marketing cost per channel) divided by marketing cost per channel:

$$ROI per channel = \frac{profit per channel - marketing cost per channel}{marketing cost per channel} \qquad Eq . 1$$

One may multiply the result of Eq. 1 by 100 to express ROI as a percentage, rather than a fraction. If profit per channel is less than marketing cost per channel, then the ROI per channel is a negative number indicating a loss. In Eq. 1, profit per channel is calculated as revenue per channel multiplied times profit margin, where the profit margin is a percentage for all offerings of the client. (In other embodiments of the disclosure, the profit margin may be a percentage for a particular offering or group of offerings.) The ROI marketing performance measurement reporting system 860 uses the correlations to create ROI performance measurement reports 870, which may include ROI per channel and which may be displayed on (or printed by) one or more of the output devices 888.

In alternative embodiments, the ROI may be calculated on a provider basis in situations where the cost and revenue are obtainable on a per provider basis. In other embodiments, the ROI may be calculated on a venue basis. The ROI may also be calculated on a marketing campaign basis, taking into account all the revenue sources and all the costs of the marketing campaign. Although FIG. 8 includes server 880 and customer server 890, other non-server computers or other computing machines similarly configured may also be used in one or more embodiments of the disclosure for these components.

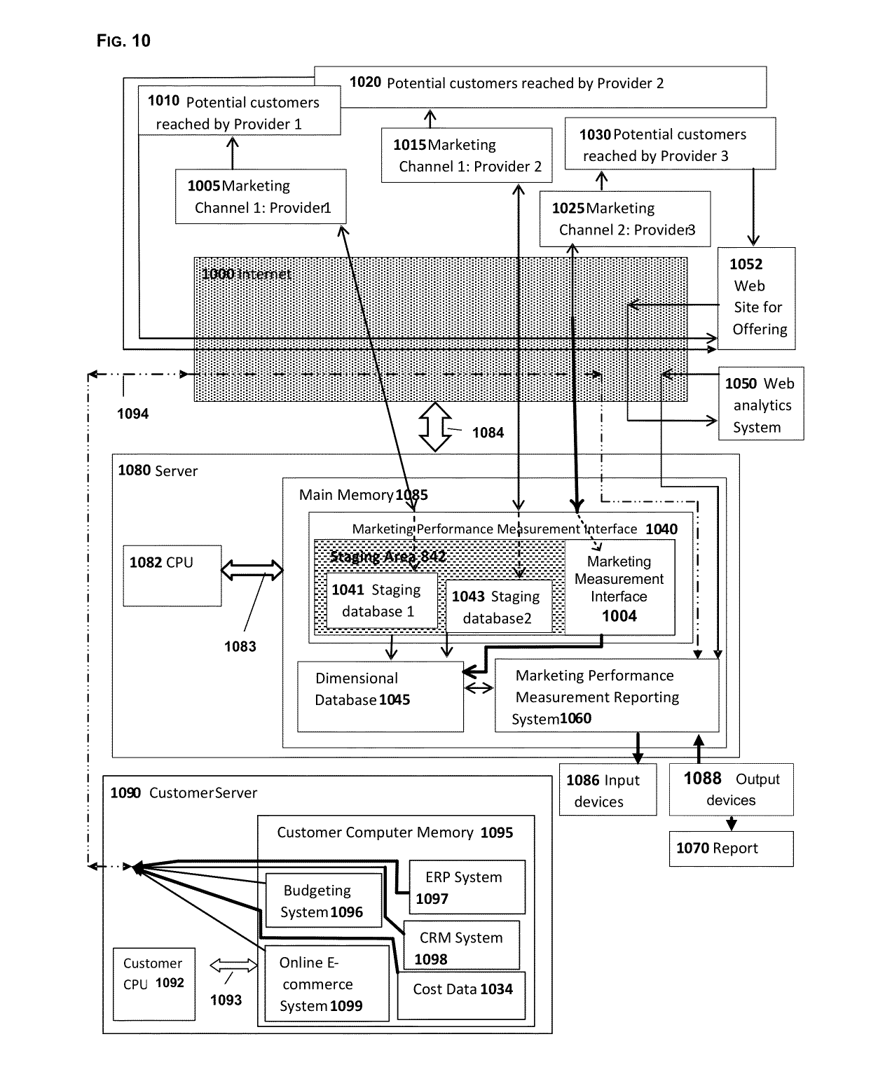

FIG. 9 is an example of a flowchart depicting a process for analyzing and comparing the performance of marketing channels on the basis of ROI, in accordance with one or more embodiments of the present disclosure. In the example of FIG. 9, two or more providers of marketing Channel 1 display/play/post 902 advertising/marketing/conversations, which are perceived by at least one potential Set 1 customer. A single provider of marketing Channel 2 displays/plays/posts 904 advertising/marketing/conversations, which are perceived by at least one potential Set 2 customer. Two or more providers of marketing Channel 3 display/play 906 advertising/marketing/conversations, which are perceived by at least one potential Set 3 customer. As in FIG. 8, none of the marketing channels of FIG. 9 is a broadcast marketing channel.

The providers of Channel 1 have 912 data on their marketing performances and may obtain feedback on actions and/or inaction by Set 1 customers, the data and feedback comprising marketing performance data for the providers of Channel 1. The provider of Channel 2 has 914 data on its marketing performance and may obtain feedback on actions/inaction by Set 2 customers, the data and feedback comprising marketing performance data for the provider of Channel 2. The Channel 3 providers have 916 data on their marketing performances and may obtain feedback on actions/inaction by Set 3 customers, the data and feedback comprising marketing performance data for the providers of Channel 3. Referring again to FIG. 9, the Channel providers send 920 their respective marketing performance data in compressed packets, in provider-specific formats, to a marketing performance measurement interface, responsive to polling by the marketing performance measurement interface. The marketing performance measurement interface extracts the marketing performance data from the compressed packets and stores the uncompressed data in its provider-specific formats in staging databases, one for each provider.

The marketing performance measurement interface converts the marketing performance data from the provider-specific formats to a specialized format of factual data and dimensional data. The marketing performance measurement interface sends 940 the marketing performance data in the specialized format to be stored in a dimensional database. Preferably, the factual data is stored on a lowest level of the dimensional database while the dimensional data is stored on other levels of the dimensional database.

For customers visiting an offering web site, a web analytics system may determine 930 to which customer set the web site visitor belongs. The web analytics system collects data on steps taken by visitor during visit. The set determinations and the step data comprise web site usage data. An ROI marketing performance measurement reporting system pulls 935 the web site usage data from the web analytics system.

The ROI marketing performance measurement reporting system also obtains 950 cost data and revenue data from systems of customer presenting offering, groups 952 the cost data and the revenue data on a per marketing channel basis and calculates 954 the ROI per marketing channel. (In alternative embodiments, the ROI may be calculated on a provider basis in situations where the cost and revenue are obtainable on a per provider basis. In other embodiments, the ROI may be calculated on a venue basis or may be calculated at two or more levels of granularity. The ROI may also be calculated on a marketing campaign basis, taking into account all the revenue sources and all the costs of the marketing campaign.) The calculation of the ROI per marketing channel may use Eq. 1, as previously discussed herein. In Eq. 1, profit per channel is calculated as revenue per channel multiplied times profit margin, where the profit margin is a percentage for all offerings of the client. (In other embodiments of the disclosure, the profit margin may be a percentage for a particular offering or group of offerings.) Multiplying the result of Eq. 1 by one hundred yields the ROI as a percentage.

Referring again to FIG. 9, the ROI marketing performance measurement reporting system pulls 945 the marketing performance measurement data in the form of factual data and dimensional data from the dimensional database upon user request. The ROI marketing performance measurement reporting system correlates 960, on at least a marketing channel level of granularity, the marketing performance data, the web site usage data, the cost data, the revenue data, and the calculated ROI. The ROI marketing performance measurement reporting system uses 970 the correlated marketing performance data and web site usage data to create ROI performance measurement reports, including the ROI per marketing channel. As with FIG. 8, in alternative embodiments, the ROI may be calculated on a provider basis in situations where the cost and revenue are obtainable on a per provider basis. In other embodiments, the ROI may be calculated on a marketing venue basis. The ROI may also be calculated on an overall marketing campaign basis, taking into account all the revenue sources and all the costs of the marketing campaign.

FIG. 10 is a block diagram depicting an example of a system for analyzing and comparing marketing channels on the basis of ROI, in accordance with one or more embodiments of the present disclosure. FIG. 10 is similar to FIG. 8, but in FIG. 10, a marketing channel 2 (having a provider 3) is a broadcast marketing channel. In the example of FIG. 10, there are two marketing channels and three providers. A provider 1 1005 of a marketing channel 1, displays advertisements/marketing/conversations for an offering. Potential customers 1010 reached by the provider 1 1005 may respond by going to (or clicking through to) a website 1052 for the offering, via the internet 1000. (Some of the potential customers 1010 reached by the provider 1 1005 may respond in different ways or not at all.) A provider 2 1015 of the marketing channel 1 displays advertisements/marketing/conversations for the offering. Potential customers 1020 reached by the provider 2 1015 may respond by going to (or clicking through to) the website 1052 for the offering, via the internet 1000. (Some of the potential customers 1010 reached by the provider 2 1015 may respond in different ways or not at all.) In some cases, the potential customers reached by one provider by overlap with the potential customers reached by another provider. In FIG. 10, the potential customers 1020 reached by the provider 2 1015 have a degree of overlap with the potential customers 1010 reached by the provider 1 1005.

As previously mentioned, the marketing channel 2 is a broadcast marketing channel. The provider 3 1025 of the broadcast marketing channel 2 displays advertisements/marketing/conversations for the offering. Potential customers 1030 reached by the provider 3 1025 may respond by going to (or clicking through to) the website 1052 for the offering, via the internet 1000. (Some of the potential customers 1030 reached by the provider 3 1025 may respond in different ways or not at all.)

Referring again to FIG. 10, a server (or other computer) 1080 communicates over the internet 1000 through an internet connection 1084. (The server 1000 of FIG. 10 is a simplified version; more detail of some components of a typical server or other computer in accordance with one or more embodiments of the present disclosure is provided in FIG. 6). Communications of different components of the server 1000 with elements outside the server 1000 are depicted as direct communications via the internet for clarity, but such communications would generally be routed through server 1000 as is well known in the art and out the internet connection 1084 to their destinations via the internet.) The internet connection 1084 may be of any convenient kind, and may operate, for example, via hard wire or wirelessly. The server 1080 has a central processing unit (“CPU”) 1082 that may communicate through a bus 1083 with a main memory 1090. One or more input devices 1086 and one or more output devices 1088 allow user interaction with the server 1080. Alternatively, the input devices 1086 and/or the output devices 1088 may be part of one or more client computer systems (not depicted in FIG. 10) in communication with the server 1000.

Continuing to refer to FIG. 10, the main memory 1090 of server 1000 includes a marketing performance measurement interface 1040. The marketing performance measurement interface 1040 communicates through the internet connection 1084 and the internet 1000 with the provider 1 1005, the provider 2 1015 and the provider 3 1025. The marketing performance measurement interface 1040, collects non-broadcast marketing performance data preferably by continuously polling the provider 1 1005, and the provider 2 1015. The marketing performance measurement interface 1040 includes a staging area 1042, having a staging database for each non-broadcast provider, in this case the provider 1 1005, and the provider 2 1015. In this example, the staging area 1042 includes a staging database 1 1041 and a staging database 2 1043. The provider 1 1005 and the provider 2 1015 provide their respective marketing performance data to the marketing performance measurement interface 1040, in the form of compressed packets of data in a format specific to the sending provider. The marketing performance measurement interface 1040 extracts the marketing performance data from the compressed packets and stores the marketing performance data in the appropriate staging database 1 1041 or 2 1043, depending on which provider provided the marketing performance data, as uncompressed data in the provider-specific formats.

Broadcast marketing performance data from the provider 3 1025 is also sent to the marketing performance measurement interface 1040 in a provider-specific format, usually in the form of a spreadsheet, such as an Excel® spreadsheet. The broadcast marketing performance data from the provider 3 1025 is preferably processed by a measurement management interface 1004, as described in the previously mentioned-co-pending patent application Ser. No. ______, entitled “Methods, Systems and Apparatuses for Analyzing the Effectiveness of Broadcast Advertising in and on Integrated Marketing Campaigns.”

The marketing performance measurement interface 1040 transforms the uncompressed non-broadcast marketing performance data (from the provider 1 1005 and the provider 2 1015) and the broadcast marketing performance data (from the provider 3 1025) from the provider-specific formats to a specialized format of factual data and dimensional data, which is sent to a dimensional database 1045. At the dimensional database 1045, the marketing performance data (in the form of factual data and dimensional data) are stored. The factual data is preferably stored on the lowest level of the dimensional database.

Referring again to FIG. 10, a web analytics system 1050 collects web usage information from the web site 1052 and sends the web usage information to an ROI marketing performance measurement reporting system 1060.

FIG. 10 also depicts a customer server 1090, having a customer computer memory 1095, a customer CPU 1092, a customer computer bus 1093, and a customer computer internet connection 894. The customer computer memory 895 includes a budgeting system 896, an ERP system 1097, a CRM system 1098, and an online e-commerce system 1099. The customer computer memory 1095 may also store cost data 1034 for advertising through different marketing channels and/or providers. (In alternate embodiments, the cost data 1034 may be obtained from other sources, such as the providers.) Revenue information is sent from one or more of the budgeting system 1096, the ERP system 1097, the CRM system 1098, and/or the online e-commerce system 1099, through the customer computer internet connection 1094 and via the internet 1000, to the ROI marketing performance measurement reporting system 1060. The revenue information preferably includes a profit margin for the offering or for a product or service line including the offering. The cost data 1034 through the customer computer internet connection 1094 and via the internet 1000 to the ROI marketing performance measurement reporting system 1060.

The ROI marketing performance measurement reporting system 1060 pulls the factual data and the dimensional data from the dimensional database 1045. The ROI marketing performance measurement reporting system 1060 correlates the factual data and the dimensional data with the web usage information and with the cost data and the revenue information, the correlation being done on a per channel basis. The ROI marketing performance measurement reporting system 1060 uses the cost data and revenue data for each channel to calculate ROI of that channel. The calculation of ROI per channel may use Eq. 1, as previously discussed herein. In the Eq. 1, profit per channel is calculated as revenue per channel multiplied times profit margin, where the profit margin is a percentage for all offerings of the client. (In other embodiments of the disclosure, the profit margin may be a percentage for a particular offering or group of offerings.) The ROI marketing performance measurement reporting system 1060 uses the correlations to create ROI performance measurement reports 1070, which include ROI per channel and which may be displayed on (or printed by) one or more of the output devices 1088.

In alternative embodiments, the ROI may be calculated on a provider basis in situations where the cost and revenue are obtainable on a per provider basis. The ROI may also be calculated on a marketing campaign basis, taking into account all the revenue sources and all the costs of the marketing campaign. Although FIG. 10 includes server 1080 and customer server 1090, other non-server computers or other computing machines similarly configured may also be used in one or more embodiments of the disclosure for these components.

Turning now to FIG. 6, a depicted architecture includes a machine 3200 with a main memory 3201 storing a marketing channel ROI analysis system 100, in accordance with one or more embodiments of the present disclosure. The machine 3200 may be configured in any number of ways, including as a laptop unit, a desktop unit, a network server, mobile device, telephone, net-book, or any other configuration. The machine 3200 generally includes a central processing unit (CPU) 3202 coupled to a main memory 3201, and to a variety of other peripheral computer system components through an integrated bridge logic device 3206. The bridge logic device 3206 is sometimes referred to as a “North bridge” for no other reason than it often is depicted at the upper end of a computer system drawing. The CPU 3202 couples to the North bridge logic 3206 via a CPU bus 3254, or the bridge logic 3206 may be integrated into the CPU 3202. The CPU 3202 may comprise, for example, of an Intel® i5 Core microprocessor. It should be understood, however, that the machine 3200 could include other alternative types of microprocessors. Further, an embodiment of the machine 3200 may include a multiple-CPU architecture, with each processor coupled to the bridge logic unit 3206. An external cache memory unit 3204 may further couple to the CPU bus 3254 or directly to the CPU 3202.

The main memory 3201 couples to the bridge logic unit 3206 through a memory bus 3252. The main memory 3201 functions as the working memory for the CPU 3202 and generally includes a conventional memory device or array of memory devices in which program instructions and data are stored. The main memory 3201 may comprise any suitable type of memory such as dynamic random access memory (DRAM), or any of the other various types of DRAM devices, such as synchronous DRAM (SDRAM), extended data output DRAM (EDO DRAM), or Rambus™ DRAM (RDRAM). The North bridge 3206 couples the CPU 3202 and main memory 3201 to the peripheral devices in the system through a Peripheral Component Interconnect (PCI) bus 3258 or other expansion bus, such as an Extended Industry Standard Architecture (EISA) bus. The present disclosure, however, is not limited to any particular type of expansion bus, and thus various buses may be used, including a high speed (66 MHz or faster) PCI bus. Various peripheral devices that implement the PCI protocol may reside on the PCI bus 3258 as well.

Referring again to FIG. 6, the marketing channel ROI analysis system 100 stored in the main memory 3201 preferably includes components depicted in FIG. 1 and functions as in the description herein of that figure. Although included within FIG. 1, one or more information sources 101 (such as the revenue data sources and source of the cost data of FIG. 1), a website for the offering (not depicted in FIG. 6) and a web analytics software 150 may be external to the machine 3200 and to the marketing channel ROI analysis system 100, but would be able to communicate with the marketing channel ROI analysis system 100.

The machine 3200 includes a graphics controller 3208 that couples to the bridge logic 3206 via an expansion bus 3256. As shown in FIG. 6, the expansion bus 3256 comprises an Advanced Graphics Port (AGP) bus. Alternatively, the graphics controller 3208 may couple to bridge logic 3206 through the PCI bus 3258. The graphics controller 3208 may embody a typical graphics accelerator generally known in the art to render three-dimensional data structures on display 3210. Bridge logic 3206 includes a PCI interface to permit master cycles to be transmitted and received by bridge logic 3206. The bridge logic 3206 also includes an interface for initiating and receiving cycles to and from components on the AGP bus 3256. The display 3210 comprises any suitable electronic display device upon which an image or text can be represented. A suitable display device may include, for example, a cathode ray tube (CRT), a liquid crystal display (LCD), a thin film transistor (TFT), a virtual retinal display (VRD), a touch pad, or any other type of suitable display device.

The machine 3200 may comprise a computer system and may also optionally include a Personal Computer Memory Card International Association (PCMCIA) drive 3212 coupled to the PCI bus 3258. The PCMCIA drive 3212 is accessible from the outside of the machine and accepts one or more expansion cards that are housed in special PCMCIA cards, enclosures which are approximately the size of credit cards but slightly thicker. Accordingly, PCMCIA ports are particularly useful in laptop computer systems, in which space is at a premium. A PCMCIA card typically includes one connector that attaches to the PCMCIA port 3212, and additional connectors may be included for attaching cables or other devices to the card outside of the machine 3200. Accordingly, various types of PCMCIA cards are available, including modem cards, network interface cards, bus controller cards, and memory expansion cards.

If other secondary expansion buses are provided in the computer system, another bridge logic device 3220 typically couples the PCI bus 3258 to that expansion bus. This bridge logic is sometimes referred to as a “South bridge,” reflecting its location vis-a-vis the North bridge in a typical computer system drawing.

In FIG. 6, the South bridge 3220 couples the PCI bus 3258 to an Industry Standard Architecture (ISA) bus 3262 and to a hard drive bus 3260. The hard drive bus 3260 typically interfaces input and output devices such as a CD ROM drive and/or Digital Video Disc (DVD) drive 3258, a hard disk drive 3230, microphone and/or speaker divers 3240, camera and/or video drivers 3242, a touch pad driver 3244, and/or a mouse driver 3246 in accordance with the embodiment of the disclosure shown in FIG. 6. The hard drive bus 3260 shown in FIG. 6 couples to the hard drive 3230, which has nominal space 3232 and may have other memory.

Also in FIG. 6, various ISA-compatible devices are depicted as coupled to the ISA bus 3262, including a BIOS ROM 3216. The BIOS ROM 3216 typically is a “nonvolatile” memory device, which means that the memory contents remain intact even when the machine 3200 powers down. By contrast, the contents of the main memory 3201 typically are “volatile” and thus are lost when the computer shuts down.

The South bridge 3220 of FIG. 6 supports an input/output controller 3222 that operatively couples to basic input/output devices such as a keyboard 3247, a mouse 3246, a CD/DVD drive 3258, general purpose parallel and serial ports 3248, and various input switches such as a power switch and a sleep switch (not shown). The I/O controller 3222 typically couples to the South bridge via a standard bus, shown as the ISA bus 3262 in FIG. 6. A serial bus 3264 may provide an additional connection between the I/O controller 3222 and South bridge 3220. The I/O controller 3222 typically includes an ISA bus interface (not specifically shown) to transmit and receive registers (not specifically shown) for exchanging data with the South bridge 3220 over the serial bus 3264.

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure also described various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A method, comprising:
collecting by a specially programmed computer system over a time period, cost data for a marketing campaign for an offering of a vendor, the marketing campaign including at least two providers being from at least one marketing venue in at least one marketing channel, the at least two providers making marketing communications for the offering in the marketing campaign;
collecting by the specially programmed computer system from a revenue data system in near real time, over the time period, revenue data for the offering generated by the marketing campaign;
obtaining, by the specially programmed computer system, a profit margin on at least a vendor level of granularity;
grouping, by the specially programmed computer system, of the cost data and the revenue data into categories for at least one desired level of granularity and separating any revenue data that cannot be grouped as ungrouped revenue data;
pulling, in near real time from a web analytics system, web site usage data about the impact of the marketing communications on a website relating to the offering;
correlating, by the specially programmed computer system, the web site usage data with the ungrouped revenue data to group the ungrouped revenue data into the categories for the at least one desired level of granularity;
determining, by the specially programmed computer system, from the grouped cost data and grouped revenue data and the profit margin, returns on investment (“ROI's”) at the at least one desired level of granularity; and
displaying, on a display in communication with by the specially programmed computer system, the determined ROI's on at the at least one desired level of granularity.

2. The method of claim 1, further comprising:
adjusting the profit margin to an adjusted profit margin and determining, grouped cost data and grouped revenue data and the adjusted profit margin, adjusted ROI's at the at least one desired level of granularity.

3. The method of claim 1, wherein the revenue data is collected on a transactional basis and further comprising:
linking, by the specially programmed computer system, the revenue of each transaction to a related category at the desired level of granularity.

4. The method of claim 1, wherein the desired level of granularity is a marketing channel level, the categories are different marketing channels and wherein the revenue of each transaction is linked to its marketing channel.

5. The method of claim 1, further comprising:
collecting, over the time period, marketing performance data regarding the marketing communications of the offering over the time period, the marketing performance data collected on a per provider basis in a provider-specific format;
transforming the marketing performance data of each provider from the provider-specific format to a specialized format of factual data and dimensional data and storing the factual data and dimensional data in a dimensional database;
correlating the marketing performance data in the specialized format with the near real time website usage data, with the grouped cost data and revenue data and with the ROI's to provide one or more performance comparisons including at least one revenue-based comparison; and
displaying the performance comparisons.

6. The method of claim 5, wherein at least one marketing channel is a non-broadcast marketing channel and the non-broadcast marketing performance data from each non-broadcast marketing channel is collected in near real time.

7. The method of claim 6, wherein the step of collecting in near real time non-broadcast marketing performance data, on a per provider basis comprises:
obtaining non-broadcast marketing performance data as a compressed data packet, on a per provider basis, from each non-broadcast provider in near real time; and
extracting the non-broadcast marketing performance data from each compressed data packet and creating for each compressed data packet an un-compressed packet of the non-broadcast marketing performance data; and
storing each uncompressed packet of the non-broadcast marketing performance data in a staging databases in a staging area, wherein the uncompressed packets of the non-broadcast marketing performance data from each provider is stored in separate staging databases.

8. The method of claim 5 wherein the at least one revenue-based comparison is a revenue comparison, a profit comparison or an ROI comparison.

9. The method of claim 1, wherein the at least one desired level of granularity is a marketing channel level of granularity, a marketing venue level of granularity, or a provider level of granularity.

10. The method of claim 1, wherein the revenue data is collected from an enterprise resource planning (“ERP”) system, a customer relationship management (“CRM”) system, an online e-commerce system, or a budgeting system.

11. The method of claim 1, wherein the step of grouping the cost data and the revenue data into categories for at least one desired level of granularity and separating any revenue data that cannot be grouped as ungrouped revenue data comprises grouping the cost data and the revenue data into categories for at least two desired levels of granularity and separating any revenue data that cannot be grouped as ungrouped revenue data;
wherein the step of correlating the web site usage data with the ungrouped revenue data to group the ungrouped revenue data into the categories for the at least one desired level of granularity comprises correlating the web site usage data with the ungrouped revenue data to group the ungrouped revenue data into the categories for the at least two desired levels of granularity;
wherein the step of determining, from the grouped costs revenue and, and the profit margin, returns on investment (“ROI's”) at the at least one desired level of granularity comprises determining, from the grouped costs and revenue and the profit margin, returns on investment (“ROI's”) at the at least two desired levels of granularity; and
wherein the step of displaying the determined ROI's on at the at least one desired level of granularity comprises displaying the determined ROI's on at the at least two desired levels of granularity.

12. The method of claim 1, wherein the revenue data is collected on a transactional level of granularity and is re-grouped into a higher level of granularity.

13. The method of claim 1, wherein the returns on investment are determined using a formula:
$$ROI per channel = \frac{profit per channel - marketing cost per channel}{marketing cost per channel}$$

14. The method of claim 1, wherein a return on investment are further determined by multiplying a result of the formula by one hundred to obtain the return on investment as a percentage.

15. An apparatus, comprising:
a return on investment (“ROI”) marketing performance measurement reporting system coupled to a cost system, the ROI marketing performance measurement reporting system configured to collect from the cost system cost data for a marketing campaign, the marketing campaign including a plurality of marketing communications for an offering through two or more providers from at least one marketing venue in at least one marketing channel,
wherein the ROI marketing performance measurement reporting system also coupled to a revenue system and further configured to collect in near real time from the revenue system revenue data generated from the marketing campaign, the revenue data, including a profit margin;
a web analytics system configured to obtain web site usage data related to a web site for the offering, wherein the web analytics system is coupled to the ROI marketing performance measurement reporting system, the ROI marketing performance measurement reporting system configured to pull the web site usage data from the web analytics system;
wherein the ROI marketing performance measurement reporting system is further configured to group the cost data and the revenue data into categories at a desired level of granularity;
wherein the ROI marketing performance measurement reporting system further configured to determine ROI's for the categories on the desired level of granularity from the grouped cost data, the grouped revenue data and the profit margin; and, further comprising,
a display in communication with the ROI marketing performance measurement reporting system for displaying at least one of the determined ROI's.

16. The apparatus of claim 15, further comprising:
a marketing performance data interface coupled to at least two marketing performance data systems, each of one of the at least two providers, the marketing performance data interface configured to collect, in near real time, non-broadcast marketing performance data regarding the marketing communications through at least one of the marketing performance data systems and to receive broadcast marketing performance data from at least one of the marketing performance data systems, the non-broadcast marketing performance data and the broadcast marketing performance data collected on a per provider basis and in provider-specific formats;
a staging area within the marketing performance data interface having a staging database configured to store the non-broadcast marketing performance data from a provider;
the marketing performance data interface further configured to transform the non-broadcast marketing performance data and the broadcast marketing performance data from the provider-specific formats to a specialized format of fact data and dimensional data;
a dimensional database coupled to the marketing performance data interface and configured to store the marketing performance data in the specialized format of factual data and dimensional data;
the ROI marketing performance measurement reporting system being coupled to the dimensional database, the ROI marketing performance measurement reporting system being further configured to pull the non-broadcast marketing performance data in the specialized format and broadcast marketing performance data in the specialized format from the dimensional database, to correlate the pulled non-broadcast marketing performance data and broadcast marketing performance data with the pulled web site usage data and with the cost data, revenue data and the calculated ROI to make at least one revenue-based comparison.

17. The apparatus of claim 15, wherein the revenue data source is an enterprise resource planning (“ERP”) system, a customer relationship management (“CRM”) system, an online e-commerce system, or a budgeting system.

18. The apparatus of claim 15, wherein the returns on investment, as percentages, are each determined using a formula:
$$ROI per channel = \frac{( profit per channel - marketing cost per channe ) * 100}{marketing cost per channel}$$

19. An article of manufacture comprising a medium, storing instructions that, if executed, enables a processor-based system to:
collect, over a time period, cost data for a marketing campaign including marketing communications for an offering through two or more marketing providers from a cost system coupled to the processor-based system;
collect, in near real time, revenue data generated by the marketing campaign, the revenue data collected from a revenue data system coupled to the processor-based system;
collect, over the time period in near real time, website usage data about the impact of the marketing communications on a website relating to the offering;
group the cost data and the revenue data on at a desired level of granularity;
obtain a profit margin for a line of offerings including the offering;
determine a return on investment (“ROI”) on the desired level of granularity using the grouped cost data, the grouped revenue data system and the profit margin; and
display the calculated return on investment.

20. The article of claim 19, wherein at least one marketing channel is a non-broadcast marketing channel and further comprising instructions that, if executed, enable a processor-based system to:
collect, over the time period in near real time, non-broadcast marketing performance data regarding the marketing communications of non-broadcast providers;
store the near real time marketing performance data for each non-broadcast provider in a separate staging database in provider-specific formats;
transform the marketing performance data from the provider-specific formats to a specialized format and store the near real time marketing performance data in the specialized format in a dimensional database;
correlate the marketing performance data with the near real time website usage data and with the cost data, the revenue data and the determined ROI's, wherein the desired level of granularity is a marketing channel level and the correlation includes a graphical comparison of the ROI's of at least two marketing channels; and
display the correlation.

21. A system, comprising:
a ROI marketing performance measurement reporting system;
a cost data system coupled to the ROI marketing performance measurement reporting system and configured to collect cost data for a marketing campaign, the marketing campaign including a plurality of marketing communications for an offering through two or more providers over a time period, the cost data system being further configured to send the cost data to the ROI marketing performance measurement reporting system;
a revenue system for collecting revenue data generated from the marketing campaign, the revenue system coupled to the ROI marketing performance measurement reporting system, the ROI marketing performance measurement reporting system being configured to pull the revenue data from the revenue system in near real time;
a web site for the offering;
a web analytics system configured to obtain web site usage data related to the web site for the offering, wherein the web analytics system is coupled to the ROI marketing performance measurement reporting system, the ROI marketing performance measurement reporting system configured to pull the web site usage data from the web analytics system;
wherein the ROI marketing performance measurement reporting system is further to group the cost data and the revenue data into categories at a desired level of granularity;
wherein the ROI marketing performance measurement reporting system is further configured to determine the ROI's for the categories on the desired level of granularity from the grouped cost data, the grouped revenue data and the profit margin; and
a display in communication with the ROI marketing performance measurement reporting system for displaying at least one of the determined ROI's.
